(19) United States
(12) Patent Application Publication
(10) Pub. No.: US 2011/0079933 A1
(43) Pub. Date: Apr. 7, 2011

(54) IMD/IMR TRANSFER PATTERN METHOD

(75) Inventor: Victor Shi-Yueh Sheu, Taoyuan (TW)

(73) Assignees: Victor Shi-Yueh Sheu, Taoyuan (TW); Sheng-Li Hsu, Lujhou City, Taipei County (TW)

(21) Appl. No.: 12/573,090

(22) Filed: Oct. 2, 2009

(51) Int. Cl. B29C 37/02; B29C 47/76

(52) U.S. Cl. 264/101; 264/138

(57) ABSTRACT

An IMD (in-mold decoration)/IMR (in-mold roller or in-mold release) transfer pattern method includes the steps of (a) preparing an in-mold transfer-pattern film, (b) processing the in-mold transfer-pattern film into a predetermined three-dimensional shape fitting the configuration of the desired finished product, (c) inserting the three-dimensional in-mold transfer-pattern film in an injection-molding mold for molding with a plastic material and (d) removing the molded product from the injection-molding mold after the injection-molding mold has been cooled down and then removing the thin film substrate and the release layer of the in-mold transfer-pattern film from the molded product. This method prevents the in-mold transfer-pattern film from wrinkling or cracking during injection-molding so that the finished product has a smooth perfect surface.

### BACKGROUND OF THE INVENTION

(a) Field of the Invention

The present invention relates to IMD (in-mold decoration)/IMR (in-mold roller or in-mold release) transfer pattern technology and more particularly to an IMD (in-mold decoration)/IMR (in-mold roller or in-mold release) transfer pattern method, which prevents the in-mold transfer-pattern film from wrinkling or cracking during injection-molding so that the finished product has a perfectly smooth surface.

(b) Description of the Prior Art

Plastic cover members of electronic devices (such as cell phones covers or notebook covers) have a fine surface design or protective covering layer. The fine surface design or protective covering layer may be formed by means of an in-mold transfer-printing technique. A conventional in-mold transfer-printing method (as illustrated in FIGS. 1˜4) comprises the step of preparing an in-mold transfer-printing film 10 having a printing layer 101 and attaching the in-mold transfer-printing film 10 to a female mold member 20 in front of the cavity 201 of the female mold member 20, as shown in FIG. 1; the step of closing a male mold member 30 on the female mold member 20 to force the mold block 301 of the male mold member 30 against the printing layer 101 of the in-mold transfer-printing film 10 toward the cavity 201 of the female mold member 20 and then filling a molten plastic material 40 through the male mold member 30 into the cavity 201 of the female mold member 20 for enabling the applied molten plastic material 40 to be molded on the printing layer 101 of the in-mold transfer printing film 10, as shown in FIG. 2; the step of opening the male mold member 30 from the female mold member 20, as shown in FIG. 3; and the step of removing the finished product from the mold block 301 of the male mold member 30, as shown in FIG. 4. Thus, the finished product carries the printing layer 101 on the surface.

The above prior art IMD/IMR transfer printing method uses the mold block 301 of the male mold member 30 and the molten plastic 40 to stretch the in-mold transfer-printing film 10, causing the printing layer 101 to be transfer-printed onto the molded plastic material 40. Due to the stretching ability of the in-mold transfer printing film 10 and the applied ink, this in-mold transfer-printing method is applicable to a shadow casing having smooth round corners. Further, when stretching the in-mold transfer printing film 10 during an in-mold printing process for the production of a high-relief casing or casing having a fine surface structure of fine raised lines, grooves and/or small tangential round corners, the printing layer 101 may be forced to wrinkle or to crack, resulting in a defective product.

Therefore, it is desirable to provide an IMD (in-mold decoration)/IMR (in-mold roller or in-mold release) transfer pattern method, which eliminates the aforesaid problem.

### SUMMARY OF THE INVENTION

The present invention has been accomplished under the circumstances in view. An object of the present invention is to provide an IMD (in-mold decoration)/IMR (in-mold roller or in-mold release) transfer pattern method, which allows a plastic material to be molded on an in-mold transfer-pattern film without wrinkling or cracking of the in-mold transfer-pattern film and providing a fine surface structure of fine raised lines, grooves and/or small tangential round corners.

To achieve this and other objects of the present invention, An IMD (in-mold decoration)/IMR (in-mold roller or in-mold release) transfer pattern method comprises the steps of: (1) preparing an in-mold transfer-pattern film comprising a thin film substrate, an adhesive layer, a release layer between the thin film substrate and the adhesive layer, a hard coat layer between the release layer and the adhesive layer, and a pattern layer between the hard coat layer and the adhesive layer; (2) processing the in-mold transfer-pattern film into a predetermined three-dimensional shape; (3) trimming the preshaped in-mold transfer-pattern film to a predetermined size; (4) inserting the trimmed three-dimensional in-mold transfer-pattern film in a cavity of an injection-molding mold and filling a molten plastic material into the injection-molding mold and molding the applied plastic material on the three-dimensional in-mold transfer-pattern film in the cavity of the injection-molding mold; and (5) removing the molded product from the injection-molding mold after the injection-molding mold has been cooled down and then removing the thin film substrate and the release layer from the molded product.

Further, the step of processing the in-mold transfer-pattern film into a predetermined three-dimensional shape can be achieved by means of hot pressing forming, vacuum forming or high pressure forming techniques. Because the preshaped in-mold transfer-pattern film fits the configuration of the cavity of the injection-molding mold, molding a plastic material on the in-mold transfer-pattern film does not cause the in-mold transfer-pattern film to wrinkle or to crack so that the finished product has a smooth perfect surface. Further, because the in-mold transfer-pattern film is processed into a three-dimensional configuration fitting the configuration of the cavity of the injection-molding mold, the in-mold transfer-pattern film can be processed to provide a fine surface structure of fine raised lines, grooves or small tangential round corners before injection-molding. Therefore, a finished product made according to the present invention has a fine surface structure of fine raised lines, grooves and/or small tangential round corners.

### BRIEF DESCRIPTION OF THE DRAWINGS

FIG. 1 is a schematic drawing showing the first step of a conventional in-mold transfer-printing method.

FIG. 2 is a schematic drawing showing the second step of a conventional in-mold transfer-printing method.

FIG. 3 is a schematic drawing showing the third step of a conventional in-mold transfer-printing method.

FIG. 4 is a schematic drawing showing the final step of a conventional in-mold transfer-printing method.

FIG. 5 is a flowchart of an IMD/IMR transfer pattern method in accordance with the present invention.

FIG. 6 is a sectional view of an in-mold transfer-pattern film according to the present invention.

FIG. 7 is a sectional view of an alternate form of the in-mold transfer-pattern film according to the present invention.

FIG. 8 is a schematic drawing of the present invention, showing an in-mold transfer-pattern film being processed into a predetermined three-dimensional shape.

FIG. 9 is a schematic drawing of the present invention, showing the preshaped in-mold transfer-pattern film being inserted into an injection-molding mold.

FIG. 10 corresponds to FIG. 9, showing a molten plastic material being filled into the injection-molding mold and molded on the in-mold transfer-pattern film.

FIG. 11 corresponds to FIG. 10, after the injection-molding mold is opened.

FIG. 12 corresponds to FIG. 11, after the molded product is removed from the injection-molding mold.

FIG. 13 is a schematic drawing, showing the in-mold transfer-pattern film formed integral with the molded product.

FIG. 14 corresponds to FIG. 13, after the thin film substrate and the release layer are removed from the in-mold transfer-pattern film.

FIG. 15 is a flowchart of an alternate IMD/IMR transfer pattern method in accordance with the present invention.

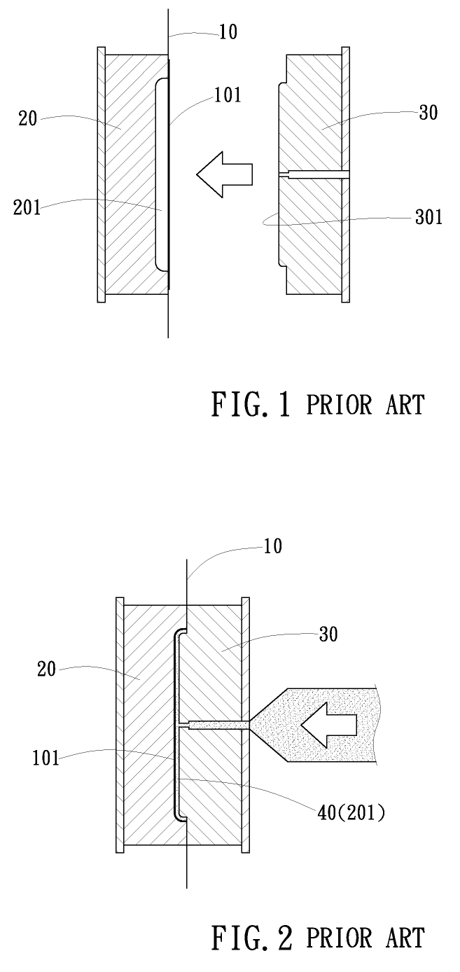

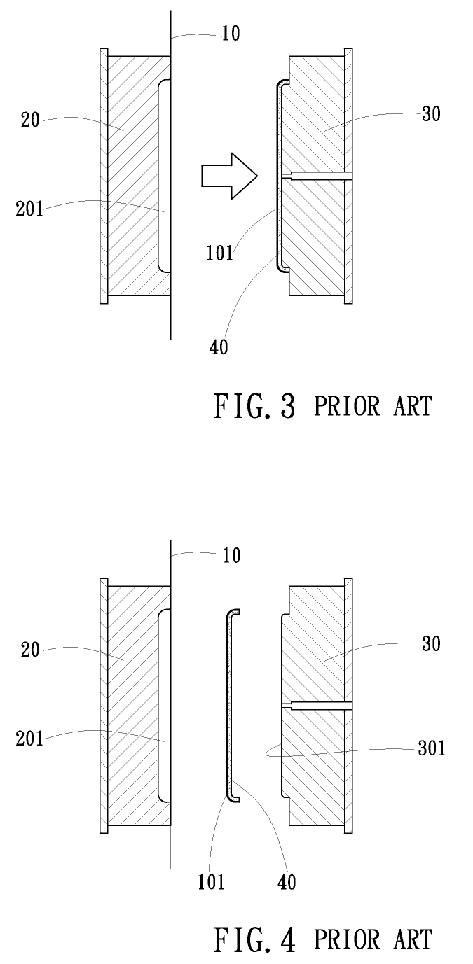

### DETAILED DESCRIPTION OF THE PREFERRED EMBODIMENTS

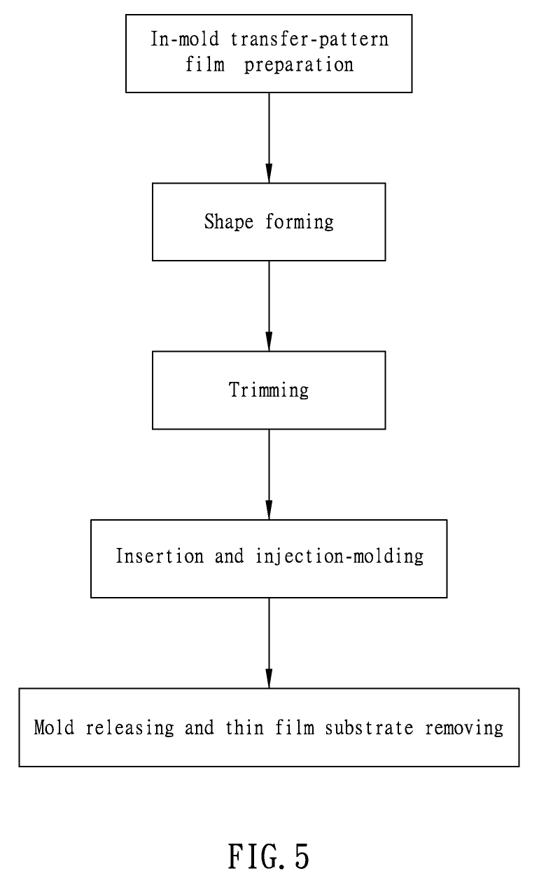

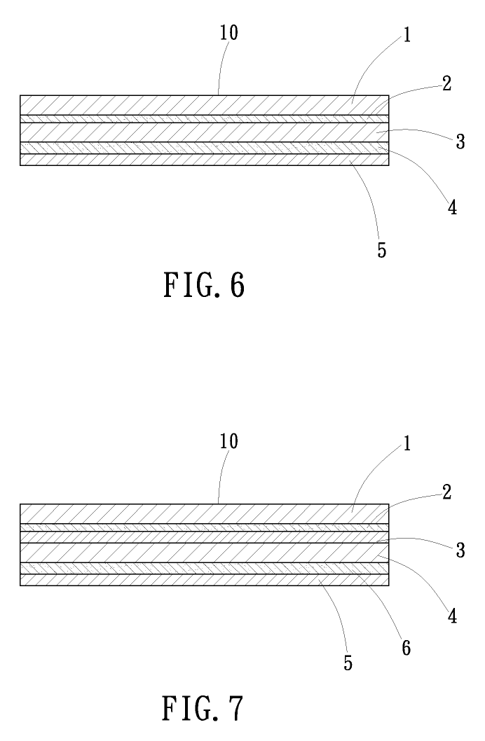

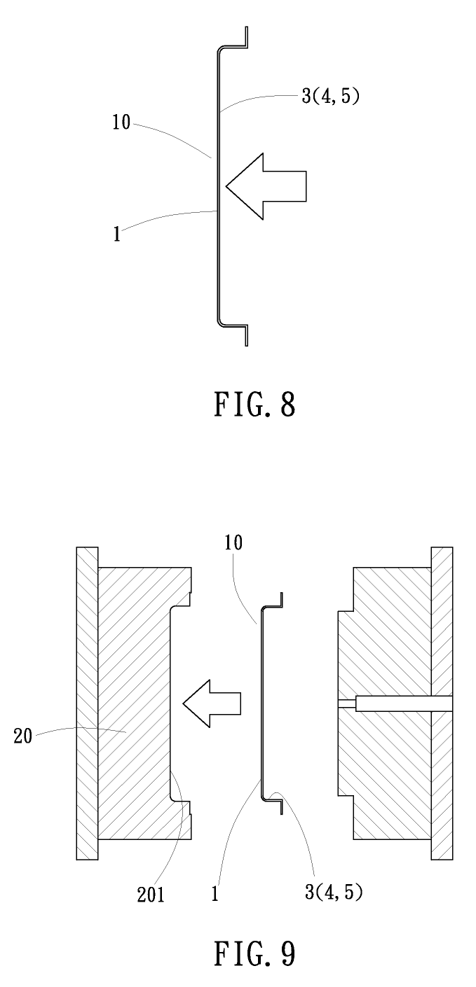

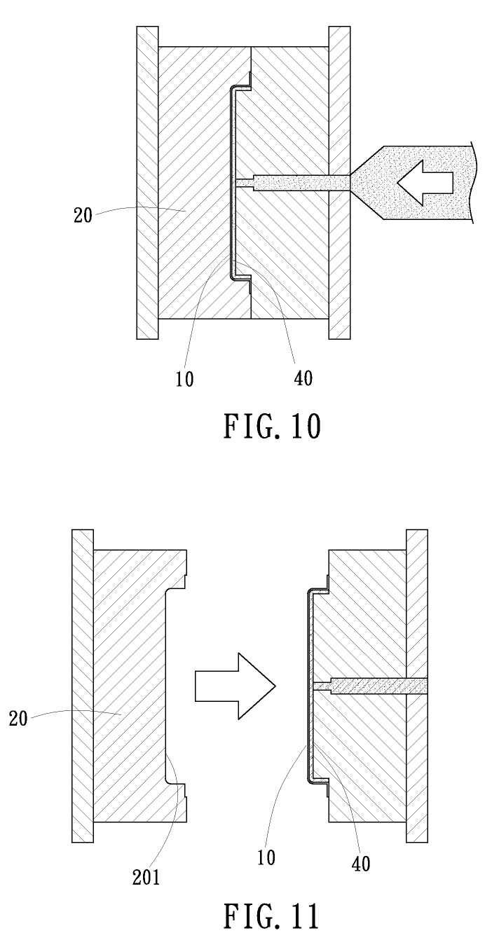

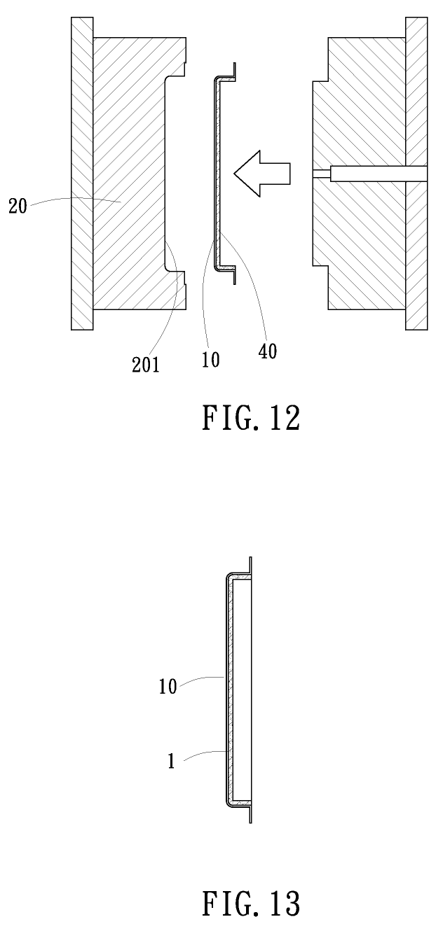

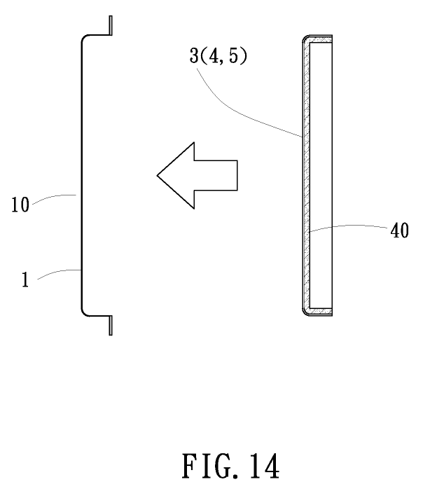

As shown in FIG. 5, an IMD/IMR transfer pattern method according to the present invention includes the following steps:
(1) In-mold transfer-pattern film 10 preparation, as shown in FIG. 6. The in-mold transfer-pattern film 10 comprises a thin film substrate 1, a release layer 2, a hard coat layer 3, a pattern layer 4 and an adhesive layer 5 arranged in proper order. The thin film substrate 1 is prepared from polymers or inorganic compounds, such as PE (polyester), PET (polyethylene terephthalate), PMMA (polymethyl methacrylate), PC (polycarbonate) or PS (polystyrene) of thermosetting film and/or thermoplastic film. The hard coat layer 3 is prepared from a polymeric material of thermosetting resin and/or thermoplastic resin (such as PU, UP, PS or the like). The pattern layer 4 is a picture, text, sign or numeral formed on the surface of the hard coat layer 3 by means of coating, spray-painting, silk screen-printing, offset printing, letterpress printing, intaglio printing or computer printing. The adhesive layer 5 is on one side, namely, the inner surface of the pattern layer 4 opposite to the hard coat layer 3. The in-mold transfer-pattern film 10 thus obtained is inserted into an injection-molding mold for further injection-molding. Further, as shown in FIG. 7, a metal layer 6 may be set between the hard coat layer 3 and the adhesive layer 5 for EMI (electromagnetic interference) protection and design exhibition. The metal layer 6 can be on the hard coat layer 3 or on the pattern layer 4 by means of sputter deposition, vacuum deposition (vacuum evaporation coating), electroplating, or directly printed on the hard coat layer 3 by a computer printer after preparation of the desired pattern through a computer.
(2) Shape forming, as shown in FIG. 8. The in-mold transfer-pattern film 10 thus obtained is processed into a predetermined three-dimensional shape fitting the configuration of the desired injection-molding product by means of one of hot pressing forming, vacuum forming and high pressure forming techniques.
(3) Trimming. The preshaped in-mold transfer-pattern film 10 is then trimmed into the desired shape and size for insertion into an injection-molding mold for further injection-molding.
(4) Insertion and injection-molding, as shown in FIGS. 9 and 10. The well-trimmed preshaped in-mold transfer-pattern film 10 is then inserted into the cavity 201 of an injection-molding mold 20, and then a molten plastic material 40 is filled into the cavity 201 and injected to the adhesive layer 5 of the inserted in-mold transfer-pattern film 10 and then molded with the inserted in-mold transfer-pattern film 10, so that the plastic material 40 is molded on the in-mold transfer-pattern film 10.
(5) Mold releasing and thin film substrate removing, as shown in FIGS. 11˜14. When the injection-molding mold 20 is cooled down and the molded plastic material 40 is hardened, open the injection-molding mold 20 and remove the molded plastic material 40 integrated with the in-mold transfer-pattern film 10 (as shown in FIG. 13) from the injection-molding mold 20, and then remove the thin film substrate 1 and the release layer 2 from the hard coat layer 3 that is bonded to the surface of the molded pattern 4 by the adhesive layer 5.

According to the aforesaid method, the in-mold transfer-pattern film 10 is processed by means of hot pressing forming, vacuum forming or high pressure forming techniques into a predetermined shape fitting the configuration of the desired injection-molding product for injection-molding with a molten plastic material 40. Because the preshaped in-mold transfer-pattern film 10 fits the configuration of the cavity 201 of the injection-molding mold 20, molding the molten plastic material 40 on the in-mold transfer-pattern film 10 does not cause the in-mold transfer-pattern film 10 to wrinkle or to crack so that the finished product has a smooth perfect surface. Further, because the in-mold transfer-pattern film 10 is to be processed into a predetermined shape before injection-molding, the in-mold transfer-pattern film 10 can be processed to provide a fine surface structure of fine raised lines, grooves or small tangential round corners before injection-molding. Thus, the invention widens the application of IMD (in-mold decoration)/IMR (in-mold roller or in-mold release) technology.

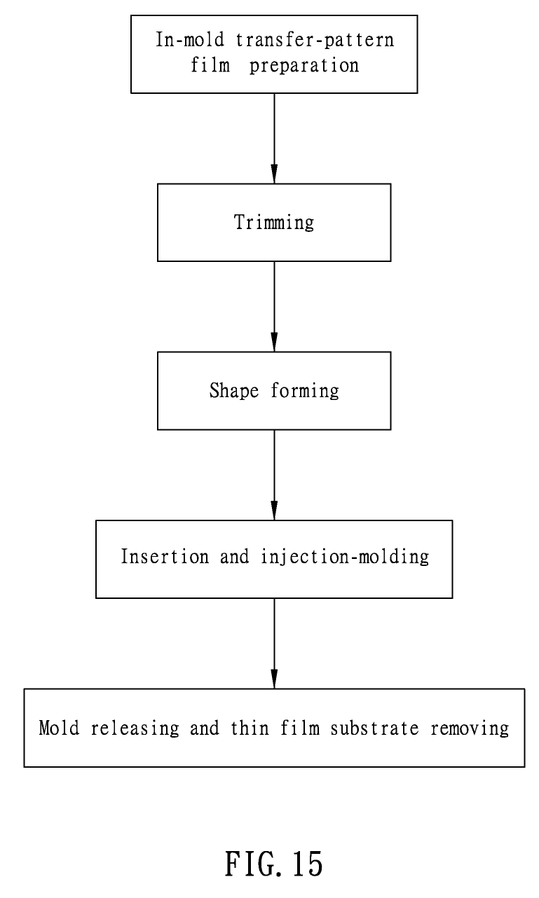

Referring to FIG. 15, the step of trimming can be performed prior to the step of shape forming, i.e., IMD/IMR transfer printing method includes the steps of: (1) In-mold transfer-printing film preparation; (2) Trimming; (3) Shape forming, (4) Insertion and injection-molding and (5) Mold release and thin film substrate removing. This alternate form achieves the same effects.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An IMD (in-mold decoration)/IMR (in-mold roller or in-mold release) transfer pattern method comprising the steps of:
(1) preparing an in-mold transfer-pattern film comprising a thin film substrate, an adhesive layer, a release layer between said thin film substrate and said adhesive layer, a hard coat layer between said release layer and said adhesive layer, and a pattern layer between said hard coat layer and said adhesive layer;
(2) processing said in-mold transfer-pattern film into a predetermined three-dimensional shape;
(3) trimming the shaped in-mold transfer-pattern film from (2) to a predetermined size;
(4) inserting the trimmed three-dimensional in-mold transfer-pattern film from (3) in a cavity of an injection-molding mold and filling a molten plastic material into said injection-molding mold and injection-molding the filled molten plastic material on the three-dimensional in-mold transfer-pattern film in the cavity of the injection-molding mold to form a molded product; and
(5) removing the molded product from the injection-molding mold after the injection-molding mold has been cooled down and then removing the thin film substrate and the release layer of the in-mold transfer-pattern film from the molded product.

2. The IMD (in-mold decoration)/IMR (in-mold roller or in-mold release) transfer pattern method as claimed in claim 1, wherein said in-mold transfer-pattern film further comprises a metal layer between said hard coat layer and said adhesive layer.

3. The IMD (in-mold decoration)/IMR (in-mold roller or in-mold release) transfer pattern method as claimed in claim 1, wherein the step of processing said in-mold transfer-pattern film into a predetermined three-dimensional shape is performed by hot pressing forming, vacuum forming, or high pressure forming.

4. An IMD (in-mold decoration)/IMR (in-mold roller or in-mold release) transfer pattern method comprising the steps of:
(1) preparing an in-mold transfer-pattern film comprising a thin film substrate, a adhesive layer, a release layer between said thin film substrate and said adhesive layer, a hard coat layer between said release layer and said adhesive layer, and a pattern layer provided between said hard coat layer and said adhesive layer;
(2) trimming the in-mold transfer-pattern film to a predetermined size;
(3) processing the trimmed in-mold transfer-pattern film from (2) into a predetermined three-dimensional shape;
(4) inserting the trimmed and shaped three-dimensional in-mold transfer-pattern film from (3) in a cavity of an injection-molding mold and filling a molten plastic material into said injection-molding mold and injection-molding the filled molten plastic material on the three-dimensional in-mold transfer-pattern film in the cavity of the injection-molding mold to form a molded product; and
(5) removing the molded product from the injection-molding mold after the injection-molding mold has been cooled down and then removing the thin film substrate and the release layer of the in-mold transfer-pattern film from the molded product.

5. The IMD (in-mold decoration)/IMR (in-mold roller or in-mold release) transfer pattern method as claimed in claim 4, wherein said in-mold transfer-pattern film further comprises a metal layer between said hard coat layer and said adhesive layer.

6. The IMD (in-mold decoration)/IMR (in-mold roller or in-mold release) transfer pattern method as claimed in claim 4, wherein the step of processing said in-mold transfer-pattern film into a predetermined three-dimensional shape is performed by hot pressing forming, vacuum forming, or high pressure forming.
